(19) United States
(12) Patent Application Publication
(10) Pub. No.: US 2026/0117004 A1
(43) Pub. Date: Apr. 30, 2026

(54) DISPERSIONS OF SYNDIOTACTIC POLYBUTADIENE AND METHODS OF PREPARING THE SAME

(71) Applicant: BRIDGESTONE CORPORATION, Tokyo (JP)

(72) Inventors: Rita E. Cook, Akron, OH (US); Piotr Kozminski, Akron, OH (US); Walter A. Salamant, Akron, OH (US); Mark N. Dedecker, North Canton, OH (US)

(21) Appl. No.: 19/141,745

(22) PCT Filed: Dec. 20, 2023
(86) PCT No.: PCT/US2023/085054

§ 371 Date: Jun. 20, 2025

Related U.S. Application Data
(60) Provisional application No. 63/476,546, filed on Dec. 21, 2022.

(51) Int. Cl. C08F 36/06; C08K 5/41

(52) U.S. Cl. CPC C08F 36/06; C08K 5/41

(57) ABSTRACT

A flowable dispersion at room temperature of syndiotactic poly butadiene particles in an aqueous mixture that includes at least one emulsifier. The dispersion reduces the need for temperature control equipment for storing or transferring the dispersion during processing. The syndiotactic poly butadiene particles in the dispersion are formed from a syndiotactic poly butadiene cement including hydrocarbon solvents resulting from a polymerization process that are subsequently removed from the dispersion by evaporation.

### TECHNICAL FIELD

The present disclosure relates to dispersions of syndiotactic polybutadiene and, in particular, to aqueous dispersions of solidified syndiotactic polybutadiene particles with an emulsifier that are flowable at room temperature. The present disclosure also relates to methods of preparing aqueous dispersions of syndiotactic polybutadiene from a syndiotactic polybutadiene-containing cement following polymerization.

### BACKGROUND

Polymerization of syndiotactic polybutadiene in hydrocarbon solvents results in a polymer cement that is transferred for storage or further used in a downstream process. The production of syndiotactic polybutadiene can present challenges because the polymer is often poorly soluble in the polymerization solvents and can solidify and aggregate into a mass below higher solubility temperatures, which diminishes the flowability of the cement and makes it difficult to transport.

To prevent solidification of the syndiotactic polybutadiene, the cement or post-polymerization contents must be kept above the solubility temperature of the polymer in order to aid transfers or storage, for instance, to a solvent removal process for preparing a polymer product. If solidification of the polymer in the cement proceeds, the cement must be re-heated to form a flowable liquid for processing. The temperature control needed to process syndiotactic polybutadiene makes polymerization production and downstream processes challenging and can require precise timing, advanced equipment set ups, monitoring and controls. Even short-term storage of a syndiotactic polybutadiene-containing cement in a standard vessel requires outfitting it with a heating means to maintain a flowable cement. Additional risk of fouling of components that are not heated or that lose heat temporarily is an undesirable factor when processing syndiotactic polybutadiene-containing cements at lower temperatures.

There is a need to improve the flowable properties and solidification difficulties of syndiotactic polybutadiene-containing cement following polymerization. The present disclosure addresses methods that increase the flowability of syndiotactic polybutadiene cements following polymerization and further result in improved storability of the cement with reduced risk of solidification and fouling of equipment.

### SUMMARY

In a first aspect, there is disclosed a syndiotactic polybutadiene dispersion that includes solidified syndiotactic polybutadiene particles in an aqueous mixture with an emulsifier.

In one example of aspect 1, the dispersion includes one or more hydrocarbon polymerization solvents, for example, hexane or butene.

In another example of aspect 1, the dispersion is substantially free, for example, less than 0.05 weight percent based on the total weight of the dispersion, of hydrocarbon solvents such as those residual solvents remaining from polymerization or the syndiotactic polybutadiene cement used to form the dispersion.

In another example of aspect 1, the emulsifier is a sulfonate compound or a sulfate compound. The sulfate compound can be sodium lauryl sulfate, sodium tetradecyl sulfate, sodium dodecyl sulfate, and combinations thereof.

In another example of aspect 1, the weight ratio of the emulsifier to the syndiotactic polybutadiene particles in the dispersion is in the range of 2 to 20.

In another example of aspect 1, the total amount of emulsifier present in the dispersion is in a range of 0.05 to 3 weight percent based on the total weight of the dispersion. In an example, the dispersion contains only one emulsifier, which can be a sulfate compound.

In another example of aspect 1, the syndiotactic polybutadiene particles present in the dispersion are in a range of 2 to 20 weight percent based on the total weight of the dispersion.

In another example of aspect 1, the water present in the dispersion is in a range of 35 to 65 weight percent based on the total weight of the dispersion.

In another example of aspect 1, the syndiotactic polybutadiene particles of the dispersion are uniformly distributed solid particles, and the dispersion is flowable at room temperature or in the range of 20° to 30° C.

In a second aspect, there is disclosed a rubber composition comprising the syndiotactic polybutadiene particles and the emulsifier of the syndiotactic polybutadiene dispersion of aspect 1, wherein the rubber composition is substantially free of the water and solvents that were present in the dispersion.

In one example of aspect 2, the rubber composition is substantially free of any polymerization solvent present in the syndiotactic polybutadiene dispersion of aspect 1.

In another example of aspect 2, the rubber composition includes 0.1 to 3 parts by weight of the emulsifier from the dispersion based on 100 parts of a rubber component of the rubber composition.

In another example of aspect 2, the rubber composition includes 1 to 30 parts by weight of the syndiotactic polybutadiene particles from the dispersion based on 100 parts of a rubber component of the rubber composition.

In another example of aspect 2, the rubber composition includes 10 to 20 phr of the syndiotactic polybutadiene particles from the dispersion.

In a third aspect, there is disclosed a method of preparing a syndiotactic polybutadiene dispersion, the method includes multiple steps of combining a syndiotactic polybutadiene polymerization cement with water and an emulsifier to form a pre-mixture, subjecting the pre-mixture to a mixing step to form a dispersion, and cooling the dispersion to solidify the syndiotactic polybutadiene present in the dispersion, for instance dissolved in the dispersion, into particles to form a final, flowable dispersion.

In an example of aspect 3, the mixing step includes applying shear force to the pre-mixture, for example, a high shear force.

In another example of aspect 3, the pre-mixture is at a temperature greater than 60° C. during the beginning of the mixing step. The pre-mixture can further be maintained at a temperature greater than 60° C. during the mixing step before cooling the formed dispersion.

In another example of aspect 3, the dispersion can include a weight ratio of the emulsifier to the syndiotactic polybutadiene in the cement being in the range of 2 to 20.

In another example of aspect 3, the pre-mixture comprising at least one of the following amounts: the syndiotactic polybutadiene present in the pre-mixture being in a range of 2 to 20 weight percent based on the total weight of the pre-mixture; the water present in the pre-mixture being in a range of 35 to 65 weight percent based on the total weight of the pre-mixture; and the total amount of emulsifier present in the pre-mixture being in a range of 0.05 to 3 weight percent based on the total weight of the pre-mixture.

In another example of aspect 3, the solidified syndiotactic polybutadiene particles of the dispersion of are uniformly distributed solid particles and the dispersion is flowable at room temperature or in the range of 20° to 30° C.

In a fourth aspect, there is disclosed a method of preparing a syndiotactic polybutadiene dispersion, the method includes multiple steps of combining a syndiotactic polybutadiene cement from a reaction vessel with a stream that includes water and an emulsifier to form a pre-mixture, feeding the pre-mixture to a colloid mill to subject the pre-mixture to mixing to form a dispersion, and cooling the dispersion discharged from the colloid mill to solidify the syndiotactic polybutadiene into particles.

In an example of aspect 4, the colloid mill applies shear force to the pre-mixture.

In another example of aspect 4, the step of combining the syndiotactic polybutadiene cement from the reaction vessel with the stream of water and emulsifier is an in-line process. An example of the in-line process is converging a first pipe with a second pipe to form a single feed pipe to the colloid mill. The first pipe includes a flow of the syndiotactic polybutadiene cement and the second pipe includes a flow of the water and emulsifier.

In another example of aspect 4, the step of combining the syndiotactic polybutadiene cement from the reaction vessel with the stream of water and emulsifier occurs in a concentric tube in fluid communication with the inlet of the colloid mill. The concentric tube includes an inner tube and an outer tube. The inner tube includes one of the syndiotactic polybutadiene cement or the water and emulsifier and the outer tube includes one of the syndiotactic polybutadiene cement or the water and emulsifier, which ever component is not in the inner tube.

In another example of aspect 4, the colloid mill has a gap between outer surface of the rotor and the inner wall surface of the casing of the mill or the inner wall surface of a stator such that the pre-mixture flows in the gap during mixing. The gap is in the range of 0.02 to 2.3 millimeters (mm).

another example of aspect 4, the colloid mill has a rotor and is operated in a range of 700 to 7500 revolutions per minute (rpm) or 2000 to 4500 rpm.

In another example of aspect 4, the pre-mixture being fed to the colloid mill at a temperature in the range of 70° to 100° C.

In another example of aspect 4, the emulsifier in the pre-mixture being present in a range of 2 to 10 parts per 100 parts of syndiotactic polybutadiene.

In another example of aspect 4, the stream that includes water and an emulsifier is fed from a supply tank holding a pre-formed slurry that includes water and one or more emulsifiers.

In another example of aspect 4, the syndiotactic polybutadiene cement and the stream of water and emulsifier are combined immediately before being fed to the colloid mill. For example, the components are combined less than 1 minute, less than 30 seconds, or less than 15 seconds before being fed to the colloid mill.

In another example of aspect 4, the weight ratio of water to the weight of the siotactic polybutadiene cement is in the range of 1:1 to 5:1, or 1.5:1 to 3:1.

The above aspects (or examples of those aspects) may be provided alone or in combination with any one or more of the examples of that aspect or another aspect discussed above; e.g., the first aspect may be provided alone or in combination with any one or more of the examples of the first aspect, second aspect, third aspect or other aspects discussed above.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

The above and other features, examples and advantages of aspects or examples of the present disclosure are better understood when the following detailed description is read with reference to the accompanying drawing, in which:

FIG. 1 shows a process schematic for a method of preparing a dispersion of syndiotactic polybutadiene following polymerization.

FIG. 2 shows a process schematic for a method of preparing a dispersion of syndiotactic polybutadiene following polymerization.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably less than or not more than 25. In an example, such a range defines independently 5 or more, and separately and independently, 25 or less.

The terms “substantial,” “substantially,” and variations thereof as used herein are intended to note that a described feature is equal or approximately equal to a value or description. For example, a “substantially planar” surface is intended to denote a surface that is planar or approximately planar. It also is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The present disclosure relates to a flowable dispersion of syndiotactic polybutadiene particles in an aqueous mixture that includes at least one emulsifier. The dispersion is flowable at lower temperatures (<30° C.), including room temperature, and beneficially reduces the need for temperature control equipment and monitoring for storing or transferring the dispersion during processing operations. The syndiotactic polybutadiene particles in the dispersion can be formed from syndiotactic polybutadiene cement, for example, a syndiotactic polybutadiene cement resulting from a polymerization process. The syndiotactic polybutadiene cement can include one or more hydrocarbon solvents that were utilized as polymerization solvents including dissolved or aggregated clumps or masses of formed syndiotactic polybutadiene.

The dispersion of syndiotactic polybutadiene is prepared by processing a syndiotactic polybutadiene following its polymerization. A syndiotactic polybutadiene cement or reaction product containing one or more hydrocarbon solvents, preferably at a temperature equal to or above that needed for solubilizing the syndiotactic polybutadiene in the one or more hydrocarbon solvents or that for making the cement flowable for mixing purposes, is combined with water and an emulsifier, for instance a slurry of water and emulsifier. In an example, the syndiotactic polybutadiene cement is at a temperature such that the syndiotactic polybutadiene is entirely dissolved in the solvents present in the cement when water and an emulsifier are combined with the cement. The combined syndiotactic polybutadiene cement, water and emulsifier are subjected to mixing to form a dispersion of syndiotactic polybutadiene particles in the mixture of hydrocarbon solvent from polymerization, water and emulsifier. The mixing is preferably performed at the same or similar temperature as used for combining water and emulsifier with the syndiotactic polybutadiene cement.

The mixed dispersion is cooled, and the syndiotactic polybutadiene of the mixed dispersion solidifies into particles that can substantially retain their form resulting from mixing or solidify from a uniformly dispersed dissolved form. The solidified syndiotactic polybutadiene particles in the dispersion do not coalesce with one another and thus the dispersion remains flowable after a reduction in temperature from the mixing phase. The emulsifier present in the dispersion promotes the solidification of the syndiotactic polybutadiene into discrete particles that do not aggregate together. The formed dispersion can be stored or subjected to additional processing steps, for example, solvent removal to reduce the presence of any polymerization solvents in the dispersion.

As noted above, the syndiotactic polybutadiene dispersion can be formed by a method that starts with a syndiotactic polybutadiene-containing cement resulting from a polymerization process. The syndiotactic polybutadiene-containing cement coming from a polymerization process can be at an elevated temperature, for example, in the range of 60 to 160° C., or 70 to 120° C. The elevated temperature of the syndiotactic polybutadiene-containing cement ensures that the syndiotactic polybutadiene polymer remains dissolved or fluid and flowable in the cement for promoting transfer and storage of the polymer cement following polymerization. To process the syndiotactic polybutadiene-containing cement for forming the syndiotactic polybutadiene dispersion, it is preferred that the cement is present in a temperature of at least 60° C. or in the range of 60° to 100° C. to assist in blending and mixing other components of the dispersion such as an emulsifier.

The syndiotactic polybutadiene-containing cement can include syndiotactic polybutadiene, one or more polymerization solvents and other polymerization or unreacted compounds. In one or more embodiments, the syndiotactic polybutadiene-containing cement contains 2 to 30, 3 to 25 or 4 to 20 weight percent of syndiotactic polybutadiene based on the total weight of the syndiotactic polybutadiene-containing cement. The polymerization solvent or solvents make up substantially the remaining portion of the cement. The solvents can be an organic solvent that is inert to the polymerization reaction, for example a hydrocarbon solvent, such as aliphatic, alicyclic, and aromatic hydrocarbon compounds. The hydrocarbon solvent preferably has from 3 to 8 carbon atoms, examples of which include propane, n-butane, isobutane, n-pentane, isopentane, n-hexane, cyclohexane, propene, 1-butene, isobutene, trans-2-butene, cis-2-butene, 1-pentene, 2-pentene, 1-hexene, 2-hexene, benzene, toluene, xylene, and ethylbenzene. These solvent compounds may be used alone or as a mixture of two or more kinds thereof.

The syndiotactic polybutadiene-containing cement is initially combined with water, one or more emulsifiers, a mixture of both, and other components to form a pre-mixture that can be mixed to form a dispersion. The combining of water and emulsifier can be carried out by adding the components to the syndiotactic polybutadiene-containing cement, for example, individually or together, or introducing the cement into water and/or emulsifier. A combination of water and total emulsifier can be optionally pre-heated before the cement component is added. In one example, water and emulsifier can be pre-heated in a vessel or desolventizer prior to charging a syndiotactic polybutadiene-containing cement to the water and emulsifier mix. Operation of the mixing step in a desolventizer can beneficially remove polymerization solvents from the mixture and reduce or eliminate downstream operations that address solvent removal of the formed dispersion. Temperature in a desolventizer can be maintained above the boiling point of the polymerization solvents but below that of the water and emulsifier mix, for example, in the range of 60° to 95° C., or 65° to 80° C. The vessel or desolventizer can be equipped with an agitator or other mixing means in order to carry out the mixing step on the pre-mixture for forming the syndiotactic polybutadiene dispersion.

Combining the components can take place in a vessel or suitable container such that the components can be introduced by conventional means (e.g., a transfer pump). The water and emulsifier can be at any suitable temperature when being combined with the polymer cement, for instance, in a temperature range of 20° to 60° C., 25° to 50° C. or 30° to 40° C. The formed pre-mixture should be at a temperature at least 60° C. or in the range of 60° to 100° C. to assist in blending and mixing other components of the dispersion.

In another embodiment, the pre-mixture of the syndiotactic polybutadiene-containing cement, water, one or more emulsifiers, a mixture of both, and other components can be formed in line by combining a stream of the syndiotactic polybutadiene-containing cement transported from a reaction vessel with a stream containing at least water and one or more emulsifiers. For example, syndiotactic polybutadiene-containing cement from a discharge or outlet pipe of a reaction vessel can be combined with a stream that includes water and one or more emulsifiers. The water and one or more emulsifiers can be pre-formed prior to combining with the reaction vessel discharge of, for example, a slurry of water and one or more emulsifiers can be prepared in a vessel and transferred to combine with the discharge stream of syndiotactic polybutadiene-containing cement to form a pre-mixture. The set up of using existing equipment and piping to process and combine the components achieves an efficient method that reduces manufacturing time and worker requirements to produce syndiotactic polybutadiene dispersions for downstream compounding.

The point of combining the stream of water and emulsifier and the discharge of reaction cement can be heated if desired to control the temperature drop in the reaction cement stream caused by combining it with water and emulsifier at a lower temperature. If a quick or significant temperature drop occurs in the reaction cement the syndiotactic polybutadiene can rapidly precipitate and/or a plug or fouling in the lines can occur. To control the temperature of the formed pre-mixture, the pipes can be insulated to heat traced. The lines providing the feeds of reaction cement and mixture of aqueous emulsifier (e.g., a slurry) can be further equipped with check valves to ensure that back-mixing and fouling is prevented in the feed lines.

The feed lines of aqueous emulsifier and reaction cement can be joined to form a single feed line that connects to the inlet of a colloid mill. The length of the single feed line to the colloid mill should be minimized to avoid risk of polymer precipitation and line fouling or plugging. In another example, the inlet to the colloid mill can be a tube-in-tube or concentric tube configuration such that the two streams meet or converge together directly or significantly close to the inlet of colloid mill to avoid risk of line plugs or precipitation. The tube-in-tube arrangement may include the syndiotactic polybutadiene-containing cement flowing in the center tube and the water and emulsifier flowing in the outer tube or, alternatively, the opposite arrangement.

The colloid mill can be any suitable mill, for example, a CBT-50 mill from Ensight. The colloid mill may have adjustable settings such as the mill gap or the distance that occurs between the outer surface of the rotor and the inner wall surface of the mill casing. Mill gap setting can be in the range of 0.02 to 2.3 millimeters (mm), 0.05 to 2 mm, 0.1 to 1.5 mm or 0.25 to 1 mm. The rotational speed of the rotor also may be adjusted and can be in the range of 700 to 7500 revolutions per minute (rpm), 1000 to 6000 rpm, 1500 to 5000 rpm or 2000 to 4500 rpm.

The pre-mixture includes at least syndiotactic polybutadiene, one or more polymerization solvents, one or more emulsifiers and water. The syndiotactic polybutadiene is preferably flowable and can be present as dissolved in the polymerization solvent. The syndiotactic polybutadiene is present in the range of 2 to 30, 3 to 25 or 4 to 20 weight percent based on the total weight of the pre-mixture. The water is preferably present in the pre-mixture in the range of 30 to 80, 35 to 65 or 40 to 60 weight percent based on the total weight of the pre-mixture. The one or more polymerization solvents can be present in the pre-mixture in the range of 20 to 55, 25 to 50 or 30 to 45 weight percent based on the total weight of the pre-mixture. The one or more emulsifiers can be present in the pre-mixture in the range of 0.05 to 5, 0.1 to 3 or 0.25 to 2 weight percent based on the total weight of the pre-mixture. In another example, the syndiotactic polybutadiene-containing cement, inclusive of the polymerization solvents and syndiotactic polybutadiene, can be present in the pre-mixture in the range of 30 to 80, 35 to 65 or 40 to 60 weight percent based on the total weight of the pre-mixture.

In one or more embodiments, the amount of total emulsifier in the pre-mixture can be measured as compared to total content of syndiotactic polybutadiene in the cement or pre-mixture. For example, the weight ratio of total emulsifier to syndiotactic polybutadiene in the pre-mixture or the weight ratio of total emulsifier in the pre-mixture to the syndiotactic polybutadiene-containing cement incorporated into the pre-mixture can be in the range of 2 to 25, 3 to 20, 4 to 15 or about 5, 8, 10 or 12. In one or more embodiments, the weight ratio of total emulsifier to syndiotactic polybutadiene in the pre-mixture is less than 10, less than 8, less than 6, less than 5, less than 4 or less than 3.

The emulsifier in the pre-mixture can be at least one ionic surfactant, for example, the ionic surfactant is at least one of a sulfonate or a sulfate compound. Example emulsifiers include alkylbenzene sulfonates, such as sodium dodecylbenzene sulfonate; alkyl sulfates, such as sodium lauryl sulfate, sodium dodecyl sulfate and sodium tetradecyl sulfate, ethoxy sulfate salts, such as polyoxy ethylene lauryl ether sulfate sodium salt and polyoxy ethylene nonylphenyl ether sulfate sodium salt and alkane sulfonates. In other embodiments, examples of suitable types emulsifying agents include, but are not limited to, anionic, nonionic, and cationic surfactants, for instance, various fatty acid soaps such as sodium stearate, rosin acid soaps, alpha olefin sulfonate, and the like.

The pre-mixture is subjected to a mixing step to disperse syndiotactic polybutadiene (e.g., from a polymerization cement) in the remaining components of the pre-mixture to form a uniform mixture. Mixing equipment as known in the art can be used to carry out the mixing step. For example, a vessel or container equipped with a mixer or agitator, such as a mechanical or motorized mixing part, can be used to form the mixture. The mixing step applies a shear force to the mixture that promotes the distribution of the syndiotactic polybutadiene into smaller particles throughout the mixture. The shear force can be generated by an in-vessel mixer or in a transfer pipe, for example, an apparatus mounted in a bypass or recirculation piping in fluid communication with a tank or vessel. In one or more embodiments, a low- or high-shear mixer can be utilized to mix the pre-mixture for forming the dispersion. Example, but non-limiting devices, include static mixers, homogenizers, pumps, magnetic stir bars, rotor/stator, agitators, orifice plates, perforated plates, nozzles, venturis, jet mixers, eductors, and static or dynamic cavitation devices.

In another example, the pre-mixture (e.g., in the form of a stream or flowing in a pipe) can be fed to a colloid mill for mixing the components and applying shear force.

The pre-mixture can be mixed for any suitable time to break up and uniformly distribute the syndiotactic polybutadiene in the water and emulsifier. In one example, the pre-mixture, at an elevated temperature of 60° to 100° C., can be mixed continuously until the mixture or dispersion reaches 20° to 25° C., or room temperature, during the mixing step or phase. The mixing step can be broken up into segments if desired depending on a particular process or equipment availability. In another example, the pre-mixture can be mixed at a constant elevated temperature or within an elevated temperature range before being allowed to cool to about room temperature, for instance, a mixing temperature in the range of 60° to 100° C. In yet another example, the pre-mixture can be mixed for 10 minutes to 4 hours, 15 minutes to 2 hours, or 30 minutes, 45 minutes, 1 hour or 1.5 hours. Mixing times can be adjusted depending on the shear force applied to the pre-mixture. For instance, mixing time can be measured by residence time in a vessel equipped with an agitator or mixing means posited in the vessel. In another example, mixing time can be measured by the passage of the mixture through a recycle loop that contains a mixing apparatus (e.g., a pump, static mixer, homogenizer, throttle valve, etc.), taking into account the volume of the recycle loop and the number of cycles through the loop.

As the mixture cools during the mixing step, or alternatively once the mixture is done being mixed at a desired temperature and then allowed to cool post-mixing, the well-mixed and distributed syndiotactic polybutadiene from the cement solidifies in the mixture to form a dispersion of syndiotactic polybutadiene. The solidified syndiotactic polybutadiene particles can vary in average particle diameter depending on the length and intensity of the mixing step. In one or more embodiments, the syndiotactic polybutadiene particles can have an average particle diameter, for instance, an average calculated by using the measured greatest diameter for each particle, in the range of 0.1 μm to 1,000 μm, 1 μm to 500 μm, 5 μm to 250 μm, or 10 μm to 100 μm. In one or more embodiments, at least 50%, at least 60%, at least 70%, at least 80% or at least 90% of the syndiotactic polybutadiene particles can have an average particle diameter of less than 10,000 μm, less than 5,000 μm, less than 2,500 μm, or less than 1,000 μm. The presence of the emulsifier in the mixture prevents the formed solid syndiotactic polybutadiene particles from coalescing or sticking together to form aggregates and, as a result, the formed dispersion in the cooled state is flowable and easily transportable.

The formed dispersion can be stored for later use or transferred directly to a downstream process. A downstream process can include solvent removal to reduce or entirely eliminate the presence of any residual polymerization solvents in the dispersion. The dispersion, upon being processed to be substantially free of solvents contained in the cement used to prepare the dispersion, remains flowable at room temperature or in the range of 20° to 30° C. The formed dispersion can thus be stored at low temperatures and reduce the need to keep the cement at elevated temperatures until the polymerization solvent is removed, which ensure the syndiotactic polybutadiene does not form a coagulated mass in the cement.

The dispersion can also be used to prepare a rubber composition, for example, a rubber composition for use as a component of a vehicle tire. The rubber composition can include other components as known in the art and can include, but are not limited to, elastomers, fillers, accelerators, cure packages, sulfur, zinc oxide, waxes, processing oils, ozone agents, antioxidants, and the like. The liquid components of the dispersion can be removed, primarily the water and any solvents, and the remaining syndiotactic polybutadiene particles and emulsifier can be dried for incorporation into a rubber composition. The liquid components can be removed as known in the art, for instance, by oven drying, vacuum evaporation, spray drying or the like. The syndiotactic polybutadiene particles and emulsifier (e.g., emulsifier either separate from or also bound to the particles) from the dispersion can be incorporated into the ingredients of the rubber composition as known in the art, for example, in a Banbury mixer, a kneader, an extruder and the like.

The dried syndiotactic polybutadiene particles can include emulsifier from the dispersion. The emulsifier to syndiotactic polybutadiene weight ratio in the dispersion can be minimized to reduce the amount of emulsifier that is present in the dried syndiotactic polybutadiene particles and thus that incorporated into the rubber composition. For example, the dried syndiotactic polybutadiene particles can include less than 20%, less than 15%, less than 12%, less than 10%, less than 8% or less than 5% by weight emulsifier or, as incorporated into a rubber composition, the total amount of emulsifier can be less than 10%, less than 8%, less than 5%, less than 4%, less than 3%, less than 1%, less than 0.5% or less than 0.25% by weight in the rubber composition. The total presence of emulsifier in the dispersion that is transferred to a rubber composition by way of using dried syndiotactic polybutadiene particles formed from the dispersion is preferably minimized to reduce any negative impact on modulus and tan δ of the rubber composition.

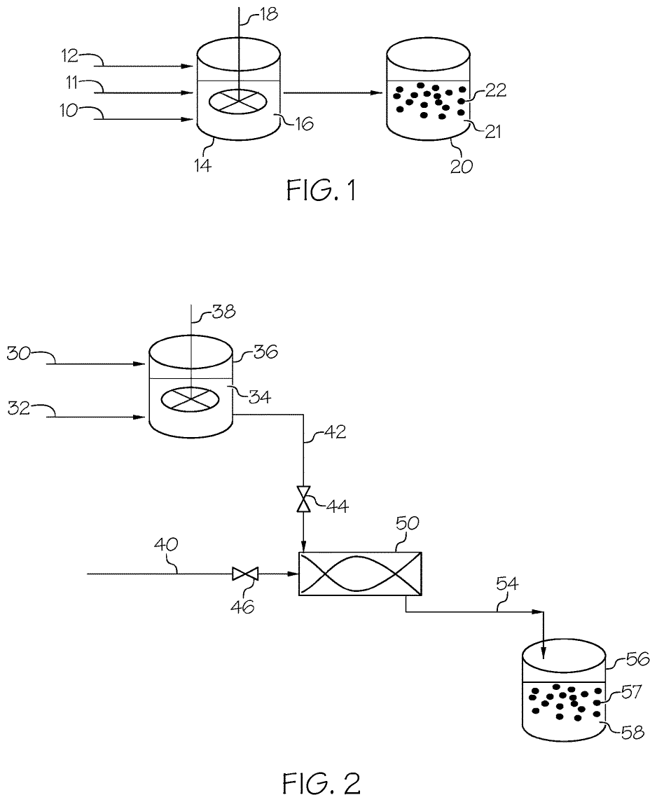

Turning to FIG. 1, there is shown a pre-mixture 16 contained in tank 14. The pre-mixture is formed by feeding water 10, an emulsifier or blend of emulsifiers 11, and a syndiotactic polybutadiene-containing cement 12 from a polymerization process to tank 14. The water 10, emulsifier 11, and cement 12 can be fed to tank 14 by a pump or suitable transfer apparatus. In an alternative example, water 10 and emulsifier 11 can be combined and fed to tank 14 as a single feed stream. In this example, water 10 and emulsifier 11 can be pre-blended in a tank or passed through an in-line mixer or pump to blend the components before being introduced into tank 14. The tank 14 can be equipped with a heating means, for example a steam jacket or heating coils, to maintain pre-mixture 16 at a temperature above the solubility temperature for the syndiotactic polybutadiene in the cement 12. In an example, pre-mixture 16 is maintained above 60° C. or in the range of 60° to 95° C., which can also provide a partial desolventization of the polymerization solvents in the cement.

Pre-mixture 16 is subjected to a mixing step that applies mixing and shear forces to the pre-mixture to form a dispersion. The mixing step can be carried out in tank 14 as shown by using a motorized mixing element 18 mounted in the tank. A mixing element 18 can be positioned or mounted in tank 14, or in any similarly suitable vessel, at desirable. For example, a mixing element can be top-mounted in a tank as illustrated in FIG. 1 or alternatively bottom-mounted. Alternatively, pre-mixture 16 can be mixed to form a dispersion in tank 14 by transferring the pre-mixture 16 through a recycle loop equipped with a mixer. The recycle loop is in fluid communication with tank 16 and reintroduced the mixed pre-mixture 16 back into tank 14 after passing through a mixer mounted in-line in the recycle loop.

The mixing step of pre-mixture 16 can include cooling the formed mixture in tank 14 while mixing by not using a heating means, for example a tank jacket, to maintain the temperature of the tank contents during the mixing step. As pre-mixture 16 mixes and forms dispersed particles of syndiotactic polybutadiene, heat is transferred through the tank walls and the formed mixture is cooled gradually during mixing and any post-mixing residence time in tank 14. In another example, the mixing step period can include a portion that mixes the pre-mixture under heating conditions to maintain the temperature of the mixture, and then a second portion that does not include heating conditions and allows the formed mixture to cool, either during a part of the mixing step, during a post-mixing period, or a combination of both operations.

The syndiotactic polybutadiene from the cement during the combination mixing and cooling step solidifies into syndiotactic polybutadiene particles that are uniformly dispersed in the water, emulsifier and remaining components of the cement. The mixing step is preferably carried out at a temperature above the solubility temperature of the syndiotactic polybutadiene in the polymerization solvents of the cement and thus partial evaporation of cement components can be accomplished during the mixing step during the formation of the fluid and flowable dispersion of solid syndiotactic polybutadiene particles. The formed dispersion 22 including syndiotactic polybutadiene particles 21 is transferred to a holding tank 20 for future use or downstream processing. Downstream processing can include solvent removal or direct incorporation into components of a rubber composition for tires. Tank 20 can also be equipped with heating means to promote further solvent removal or be in fluid communication with a solvent removal system to form a dispersion being substantially free of hydrocarbon solvents, for instance, one or more solvents used in the polymerization of the syndiotactic polybutadiene.

In FIG. 2, there is shown a pre-formed slurry 34 contained in tank 36. The pre-formed slurry is formed by feeding water 30 and an emulsifier or blend of emulsifiers 32 to tank 36. To prepare the pre-formed slurry 34, the water 30 and emulsifier 32 are subjected to a mixing step that applies mixing to achieve a slurry that is uniformly mixed. The mixing step can be carried out in tank 36 as shown by using a motorized mixing element 38 mounted in the tank. A mixing element 38 can be positioned or mounted in tank 36, or in any similarly suitable vessel, at desirable. For example, a mixing element can be top-mounted in a tank as illustrated in FIG. 2 or alternatively bottom-mounted.

The pre-formed slurry 34 is fed from tank 36 to an inlet of a colloid mill 50 by transfer line 42. To prevent back flow and pre-mature intermixing with a syndiotactic polybutadiene-containing cement 40 from a polymerization process, a check valve 44 can be optionally installed in transfer line 42, for instance, at or near the inlet to the mill. To adjust or minimize the impact the pre-formed slurry 34 has on lowering the temperature of the syndiotactic polybutadiene-containing stream, the tanks and/or transfer line 42 can be heated to maintain a desired temperature, for example, with electric tracing or jacketing.

Also supplied to an inlet of the colloid mill 50 through a transfer line (e.g., a pipe) is a syndiotactic polybutadiene-containing stream 40, such as a cement from a polymerization process. To prevent back flow and pre-mature intermixing with the pre-formed slurry 34 in transfer line 42, a check valve 46 can be optionally installed in transfer line 40, for instance, at or near the inlet to the mill. Transfer lines 40, 42 are combined at or near the inlet to the colloid mill 50 to form a pre-mixture such that the pre-formed slurry stream and the syndiotactic polybutadiene-containing stream pass through the mill and are mixed as the mill subjects the streams to a shear force to form a dispersion of particles of syndiotactic polybutadiene. Although not shown, transfer lines 40, 42 can be combined in a concentric tube arrangement, downstream of optional check valves 44, 46, such that the pre-formed slurry flows in an outer tube surrounding the syndiotactic polybutadiene-containing stream flowing in an inner tube prior to being fed together to an inlet of the mill 50.

The colloid mill 50 is equipped with a rotor that spins inside a stator as the pre-mixture is forced through a gap between the spinning rotor and stationary stator to subject the pre-mixture to shear force to promote mixing and dispersion of polymer particles. The gap between outer surface of the rotor and the inner wall surface of the casing of the mill or the inner wall surface of a stator surround the rotor is in the range of 0.02 to 2.3 millimeters (mm) and the rotor spinning within the stator can operate in a range of 700 to 7500 revolutions per minute (rpm) or 2000 to 4500 rpm. Prior to entering the inlet of the colloid mill, the pre-mixture is preferably at a temperature in the range of 70° to 100° C.

In another embodiment, the colloid mill 50 can be equipped with a heating means, for example a steam jacket or heating coils, to maintain pre-mixture at a temperature above the solubility temperature for the syndiotactic polybutadiene in the cement 40 if desired. In an example, pre-mixture is maintained above 60° C. or in the range of 70° to 100° C., which can also provide a partial desolventization of the polymerization solvents in the cement. The formed dispersion including syndiotactic polybutadiene particles 57 is fed to tank 56 through transfer line 54, which can also be heat-controlled to maintain the temperature of the dispersion, for future use or downstream processing. Downstream processing can include solvent removal or direct incorporation into components of a rubber composition for tires. Tank 56 storing dispersion 58 can also be equipped with heating means to promote further solvent removal or be in fluid communication with a solvent removal system to form a dispersion being substantially free of hydrocarbon solvents, for instance, one or more solvents used in the polymerization of the syndiotactic polybutadiene.

The dispersion can be pre-heated in a vessel or desolventizer prior to forming a product for incorporation into a rubber composition. Temperature in a desolventizer can be maintained above the boiling point of the polymerization solvents but below that of the water and emulsifier mix, for example, in the range of 60° to 95° C., or 65° to 80° C. The dispersion substantially free of solvents can be separated and vacuum dried for further compounding in a rubber composition.

### EXAMPLES

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. More specifically, the particular solvents, reaction compounds, emulsifier, rubber composition components and other ingredients utilized in the examples should not be interpreted as limiting since other such ingredients consistent with the disclosure in the Detailed Description can utilized in substitution. That is, the particular ingredients in the compositions, as well as their respective amounts and relative amounts should be understood to apply to the more general content of the Detailed Description.

### Example 1

### Polymerization of Syndiotactic Polybutadiene

To a two-gallon nitrogen purged reactor equipped with an agitator was added an approximately 20% by weight butadiene/hexanes mixture and anhydrous hexanes sufficient to prepare 5 lbs of a 15% by weight butadiene solution. The reactor was charged with a hexane solution containing 0.28 mL of iron (III) 2-ethylhexanoate and 0.37 mL of bis(2-ethylhexyl) phosphite, followed by 5.6 mL of tri-n-butylaluminum (0.68 M in hexane) diluted with hexanes. The reactor jacket was heated to 82.2° C. After 23 minutes, the batch temperature of the reaction mixture peaked at 109.7° C. When the batch temperature cooled to 82.2° C., 6.8 g of 2,6-di-tert-butyl-4-methylphenol (˜2 phr) and 2.5 lbs of cyclohexane were added to the reactor to afford a cement that contained 10% by weight syndiotactic polybutadiene. The cement of this Example was used in the following examples.

### Example 2

### Dispersion of Syndiotactic Polybutadiene

To a 750 mL glass bottle containing a stir bar was added water and sodium lauryl sulfate (SLS) in the amounts shown in Table 1. The bottle was sealed and placed in an oven at 100° C. for 30 minutes. Syndiotactic polybutadiene polymer cement at 71° C. as that prepared in Example 1 was then dropped from the reactor into the bottle in the amount shown in Table 1. The bottle was then placed on a stir plate and the stirring was set to the maximum rate at which a stable vortex was maintained until the bottle had cooled completely to room temperature. For all Samples, 2-6, the resulting dispersion was a flowable dispersion consisting of non-coalesced particles of syndiotactic polybutadiene from the cement in water that could be poured from the bottle without issue.

TABLE 1
Components of the Dispersions

| | Sam- | Sam- | Sam- | Sam- | Sam- |
|---|---|---|---|---|---|
| | ple 2 | ple 3 | ple 4 | ple 5 | ple 6 |
| Sodium lauryl sulfate ratio (wt % vs. | 2 | 5 | 10 | 20 | 15 |
| Syndiotactic polybutadiene) | | | | | |
| Sodium lauryl sulfate (g) | 0.3 | 0.8 | 1.5 | 3 | 3 |
| Water (mL) | 150 | 150 | 150 | 150 | 100 |
| Syndiotactic polybutadiene cement | 150 | 150 | 150 | 150 | 200 |
| (mL) | | | | | |

### Example 3

### Dispersion of Syndiotactic Polybutadiene

To the bucket of the miniature steam desolventizer apparatus was added 13 g of sodium lauryl sulfate (˜5 wt % vs. syndiotactic polybutadiene) and 5 L of water, and the mixture was heated to 60° C. using steam supply to the desolventizer. In a reactor with steam-traced feed lines connected to the discharge port, the syndiotactic polybutadiene cement as prepared in Example 1 was held at 60° C. With the steam-traced feed lines set at 65.5° C., the syndiotactic polybutadiene cement was transferred via pressure differential to the bucket of the miniature steam desolventization apparatus. When the addition of the cement was complete, the agitator was turned on and adjusted to the highest speed possible without causing overflow. The agitation was continued for several hours until the mixture had cooled to room temperature. Minimal fouling was observed as the result of partial desolventization of the syndiotactic polybutadiene cement during the initial cement addition. The mixing of the syndiotactic polybutadiene cement with the water and emulsifier formed a dispersion of small particles of syndiotactic polybutadiene from the cement in water that could then be easily poured from the apparatus bucket as a result of the improved flowability.

### Example 4

Rubber Compositions with Syndiotactic Polybutadiene and Emulsifier from Dispersions

The effect of emulsifier from the syndiotactic polybutadiene dispersion was studied when syndiotactic polybutadiene particles form the dispersion were used in rubber compositions. The sodium lauryl sulfate emulsifier as used in the syndiotactic polybutadiene dispersion of Example 2 was examined. Solvent from the syndiotactic polybutadiene cement of Example 1 was removed under vacuum and heating prior to incorporating the syndiotactic polybutadiene particles into a rubber composition. To evaluate the effect of sodium lauryl sulfate, the rubber compositions were loaded during the mixing stage with varying amounts of the emulsifier relative to the amount of syndiotactic polybutadiene. Additionally, a rubber composition was prepared with no sodium lauryl sulfate as a control composition. In order to mimic the addition of sodium lauryl sulfate as a component of the syndiotactic polybutadiene particles, the polymers and sodium lauryl sulfate were added to the mixer and allowed to mix briefly before the remaining ingredients were added and the rubber composition was vulcanized. The compound formulation is given in Table 2.

TABLE 2
Rubber Composition Components

| Component | Amount (phr) |
|---|---|
| Natural Rubber | 100 |
| Carbon Black (N134) | 44 |
| Syndiotactic Polybutadiene | 20 |
| Sodium Lauryl Sulfate | 0 |
| | 0.2 |
| | 1 |
| | 2 |
| Stearic Acid | 2 |
| Antioxidants | 3.5 |
| Cure Package | 6.7 |

The compound properties of the rubber compositions are summarized in Table 3 below. Some differences in compound properties were observed. Higher loadings of sodium lauryl sulfate (SLS) had a greater impact. For example, an increase in ΔG′ @ 60° C. was exhibited and a decrease in M200 were observed with the addition of sodium lauryl sulfate. A corresponding increase in tan δ @ 60° C. was also observed. These impacts were reduced with 1 wt % sodium lauryl sulfate, which was the lowest loading studied. The amount of emulsifier used in the formation of the dispersion can be reduced in order to minimize any impact on compound properties of a rubber composition.

TABLE 3
Rubber Compound Properties

| | 10 wt | 5 wt | 1 wt | 0 wt |
|---|---|---|---|---|
| | % SLS | % SLS | % SLS | % SLS |
| Tanδ @ 0° C. Index | 102 | 102 | 101 | 100 |
| G′ @ 30° C. Index | 95 | 96 | 100 | 100 |
| Tanδ @ 60° C. Index | 89 | 89 | 96 | 100 |
| ΔG′ @ 60° C. Index | 71 | 89 | 88 | 100 |
| M200 | 5.21 | 5.25 | 6.07 | 5.9 |

### Example 5

### Polymerization of Syndiotactic Polybutadiene

To a 20-gallon reactor, 36 lbs of hexane/butadiene mixture was charged as a 15 wt % butadiene solution. The butadiene solution was agitated and heated to 125° F. Once the reactor was at temperature catalyst was charged. Catalyst was charged in two phases. The first phase included 1.129 mL of iron (III) 2-ethylhexanoate (0.964 M in mineral oil), 1.486 mL of bis(2-ethylhexyl) phosphite and 50 mL of hexanes, followed by the second phase of 22.413 mL of tri-n-butylaluminum (0.68 M in hexane) diluted with hexanes. The reactor jacket was turned up to 180° F. and allowed to achieve peak exotherm. Peak was observed at 202° F. after 188 minutes after catalyst charge. The reactor was allowed to cool to around 180° F. to ensure reaction has completed. Once cooled, 27.2 g 1,3,5-Trimethly-2,4,6-tris(3,5-di-tertbutyl-4-hydroxybenzyl)benzene and 13.6 g of (Tris(nonylphenyl)Phosphite were added to the reactor, along with 10 lbs of cyclohexane to achieve a 10 wt % butadiene solution. Contents were reheated back to 190° F. in preparation for undergoing dispersion, as described in the following example.

### Example 6

### Examples of Dispersion Processes

Prior to and/or during polymerization of syndiotactic polybutadiene of Example 5, a water and emulsifier slurry was prepared and charged in a slurry tank. Calfax DB45 (emulsifier) is weighed at 5 phr relative to syndiotactic polybutadiene polymer, or 68.1 g. 60 lbs of water was added, enough to sustain the desired flow rate of 3 lb/min for 20 minutes. An excess of 50% of the slurry was prepared, maintaining the same ratios, for additional run time in case of slow down or inaccurate flow rate. The slurry tank was sealed and brought up to regulated pressure of 60 psi.

Preparation of the water and emulsifier slurry above was also formed using the same steps except that the loading level was at 2.5 phr, as opposed to 5 phr, for the emulsifier to syndiotactic polybutadiene polymer. The lower emulsifier content of this slurry can reduce any reduction in properties of the final compound performance.

Before operation, the colloid mill was set to a desired milling gap of 0.45 inch. To operate the mill, slurry flow was started and established at a flow rate of 3 lb/min. Colloid mill was started and the speed was set to 2880 rpm. Steam heating was also turned on for the heat traced-portions of syndiotactic polybutadiene cement lines and set to 220° F. to ensure good flow of cement to the mill where the cement is mixed with the slurry. Flex hose from the colloid mill outlet was placed in a receiving bucket through a custom lid with attached exhaust ventilation to prevent heavy releases of hydrocarbon solvent. The receiving bucket also contained about 1 gallon of isopropyl alcohol to terminate any remaining active catalyst present in the syndiotactic polybutadiene cement.

The reactor pressure of Example 5 was brought up to 55-60 psi for delivery of the syndiotactic polybutadiene cement to the colloid mill. Syndiotactic polybutadiene cement flow from the reactor was then commenced by opening the reactor drain valve whereas the pressure differential caused by the pressurized reactor forced syndiotactic polybutadiene cement out the drain valve. Cement flow was regulated manually, through reading flow rate and drain valve adjustment. Cement flow rate was allowed to stabilize to at about 1.5 lb/min. The resulting product stream flowing out of the colloid mill was a mixture of syndiotactic polybutadiene polymer-hexane cement with aqueous surfactant coating throughout the cement. Contact with the water from the slurry also dropped the temperature of the syndiotactic polybutadiene cement phase to below the solubility point; however, solidification was avoided as sufficient flow rates of material and shearing were maintained.

The following examples are summarized in Table 4 with variations of setpoints for ratio of syndiotactic polybutadiene cement to the emulsifier-containing aqueous slurry. Samples 1-4 in Table 4 exhibit excellent desolventization properties as described in the below step. For sample 5, emulsifier loading was reduced in order to minimize impact on compound properties. The process for sample 5 at the indicated setpoints was unable to form a pumpable dispersion product, and thus did not undergo the subsequent steam desolventization step used for samples 1-4. Data for actual flow rate is therefore not provided here for sample 5, nor in the analysis of steam desolventization efficiency as generation of the dispersion sample was unsuccessful at this level of emulsifier and selected process setpoints.

TABLE 4
Syndiotactic polybutadiene dispersions

| Process | Sam- | Sam- | Sam- | Sam- | Sam- |
|---|---|---|---|---|---|
| Setpoints | ple 1 | ple 2 | ple 3 | ple 4 | ple 5 |
| Water:Cement | 1.53 | 1.65 | 2.87 | 2.55 | N/A |
| Weight | | | | | |
| Ratio (wt) | | | | | |
| Mill Motor rpm | 2880 | 2160 | 2160 | 4320 | 4320 |
| Cement Feed | 190 | 190 | 189 | 188 | 190 |
| Temperature | | | | | |
| (° F.) | | | | | |
| Milling | 0.045 | 0.001 | 0.045 | 0.90 | 0.045 |
| Gap (inch) | | | | | |
| Emulsifier:SPB | 5 | 5 | 5 | 5 | 2.5 |
| Weight Ratio | | | | | |

### Example 7

### Examples of Dispersion Steam Desolventization

4-5 gallons of DI water, along with 20 g Polycoat LCD, was added to a steam desolventizer. Water is stirred to disperse the Polycoat and heated to operating temperatures of 180° F.-200° F. as checked by Thermo-IR thermometer. The dispersion samples collected in Example 6 were weighed to determine exact weight of water, cement, and emulsifier. Total contents of the samples were put into a payliner and agitated with air powered propeller. The agitated sample was added to steam desolventizer while monitoring the level and temperature of the desolventizer as to not over fill.

Evaluation of the dispersions was performed once the desolventization is complete and cooled. This was done by measuring weight % of “bulk” and “foul” phases formed during desolventization. These are considered to be the dispersion material within the water bath that is free and agitated, and any material caught on desolventizer internals, respectively. The weight % fouling was recorded as the % wet fouling, as water is still entrenched within the sample. Both bulk and dry material were then vacuum dried for 10 hours at 50° C. and −30 inHg. Weights were then recorded for both of these phases again once dry and recorded as the % dry fouling. These values are shown for Samples 1˜4 in Table 5 below.

TABLE 5
Characteristics of Desolventized Dispersions

| | Sam- | Sam- | Sam- | Sam- | Sam- |
|---|---|---|---|---|---|
| | ple 1 | ple 2 | ple 3 | ple 4 | ple 5 |
| Wt % Fouling - Wet | 0% | 7.63% | 2.23% | 0% | N/A |
| Wt % Fouling - Dry | 0% | 4.23% | 1.0% | 0% | N/A |

### Example 8

### Compounding Study

Effect of the dispersion of Example 6 was tested to determine appropriateness for further consideration in compounding of a rubber composition. Dispersion samples prepared as described above were submitted for testing in compounding of tread compositions noted as formulation 3 listed in Table 6 below. Tread formulations 1 and 3 respectively contained no syndiotactic polybutadiene and standard syndiotactic polybutadiene that was not added as a dispersion as made in Examples above. All amounts are shown in phr. A summary of properties of the compounded formulas is provided in Table 7.

TABLE 6
Tread compositions

| | | |
|---|---|---|
| Formulation 1 | Formulation 2 | Formulation 3 |

Masterbatch

| | | | |
|---|---|---|---|
| Natural Rubber | 70 | 70 | 70 |
| Butadiene Rubber | 30 | 30 | 30 |
| SPB - Standard | | 15 | |
| SPB - Dispersion | | | 15 |
| Carbon black | 51 | 51 | 51 |
| Processing aids | 3 | 3 | 3 |
| Antioxidants | 3.5 | 3.5 | 3.5 |

Final

| | | | |
|---|---|---|---|
| Cure package | 5.65 | 5.65 | 5.65 |

The formulations of Table 6 were produced from mixing in a tangential mixer. The masterbatch stage was mixed starting at 100° C. and 60 rpm for 5.0 minutes or until reaching a drop temperature of 155° C. The final stage was mixed at 60° C. and 40 rpm for 2.5 minutes or until reaching a drop temperature of 110° C. The green rubber formulations were cured for 25 minutes at 150° C. to prepare specimens for physical testing and shown in Table 7 below.

TABLE 7
Properties of tread compositions

| | | Formu- | Formu- | Formu- |
|---|---|---|---|---|
| | | lation 1 | lation 2 | lation 3 |
| Processing | Mooney | 71.4 | 90.7 | 87.8 |
| | viscosity, | | | |
| | 130° C. | | | |
| Cure Parameters | MH (dNm) | 18.8 | 16.1 | 16.0 |
| | T90 (min) | 10.6 | 12.6 | 11.6 |
| Tensile | M25 (25° C.) | 100 | 144 | 116 |
| | (indexed) | | | |
| | M300 (25° C.) | 16.7 | 16.7 | 15.0 |
| | M300 (100° | 12.0 | 12.7 | 11.1 |
| | C., agend) | | | |
| | EB (100° C., | 357 | 413 | 425 |
| | agend) | | | |
| Viscoelasticity | E′ (25° C.) | 100 | 155 | 122 |
| | (indexed) | | | |
| | E (60° C.) | 6.8 | 8.8 | 7.5 |
| | tan δ (60° C.) | 0.158 | 0.149 | 0.157 |
| | tan δ (100° C.) | 0.141 | 0.132 | 0.141 |

As seen in Table 7, the overall tensile properties of M300 modulus at 25° C. and 100° C. was reduced when using dispersed syndiotactic polybutadiene as compared to standard syndiotactic polybutadiene.

While various aspects and embodiments of the tires, compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A syndiotactic polybutadiene dispersion comprising
a. syndiotactic polybutadiene particles;
b. water, and
c. an emulsifier.

2. The syndiotactic polybutadiene dispersion of claim 1, further comprising one or more hydrocarbon polymerization solvents.

3. The syndiotactic polybutadiene dispersion of claim 1, the dispersion being substantially free of hydrocarbon solvents.

4. The syndiotactic polybutadiene dispersion of claim 1, the emulsifier being a sulfonate compound or a sulfate compound.

5. The syndiotactic polybutadiene dispersion of claim 4, the sulfate compound being sodium lauryl sulfate, sodium tetradecyl sulfate, sodium dodecyl sulfate, and combinations thereof.

6. The syndiotactic polybutadiene dispersion of claim 1, the weight ratio of the emulsifier to the syndiotactic polybutadiene particles in the dispersion being in the range of 2 to 20.

7. The syndiotactic polybutadiene dispersion of claim 1, the total amount of emulsifier present in the dispersion being in a range of 0.05 to 3 weight percent based on the total weight of the dispersion.

8. The syndiotactic polybutadiene dispersion of claim 1, the syndiotactic polybutadiene particles present in the dispersion being in a range of 2 to 20 weight percent based on the total weight of the dispersion.

9. The syndiotactic polybutadiene dispersion of claim 1, the water present in the dispersion being in a range of 35 to 65 weight percent based on the total weight of the dispersion.

10. The syndiotactic polybutadiene dispersion of claim 1, the syndiotactic polybutadiene particles of the dispersion being uniformly distributed solid particles and the dispersion being flowable at room temperature.

11. A rubber composition comprising the syndiotactic polybutadiene particles and the emulsifier of the syndiotactic polybutadiene dispersion of claim 1, wherein the rubber composition is substantially free of the water of the dispersion.

12. The rubber composition of claim 11, the rubber composition being substantially free of any polymerization solvent present in the syndiotactic polybutadiene dispersion of claim 1.

13. The rubber composition of claim 11, further comprising 0.1 to 3 parts by weight of the emulsifier based on 100 parts of a rubber component of the rubber composition.

14. The rubber composition of claim 11, further comprising 1 to 30 parts by weight of the syndiotactic polybutadiene particles based on 100 parts of a rubber component of the rubber composition.

15. A method of preparing a syndiotactic polybutadiene dispersion, the method comprising:
a. combining a syndiotactic polybutadiene cement with water and an emulsifier to form a pre-mixture;
b. subjecting the pre-mixture to a mixing step to form a dispersion;
c. cooling the dispersion of step b. to solidify the syndiotactic polybutadiene into particles.

16. The method of claim 15, the mixing step comprising applying shear force to the pre-mixture.

17. The method of claim 15, the pre-mixture being at a temperature greater than 60° C. during the beginning of the mixing step of step b.

18. The method of claim 15, the weight ratio of the emulsifier to the syndiotactic polybutadiene in the cement being in the range of 2 to 20.

19. The method of claim 15, the pre-mixture comprising at least one of the following amounts:
a. the syndiotactic polybutadiene present in the pre-mixture being in a range of 2 to 20 weight percent based on the total weight of the pre-mixture;
b. the water present in the pre-mixture being in a range of 35 to 65 weight percent based on the total weight of the pre-mixture; and
c. the total amount of emulsifier present in the pre-mixture being in a range of 0.05 to 3 weight percent based on the total weight of the pre-mixture.

20. The method of claim 15, the syndiotactic polybutadiene particles of the dispersion of step c. being uniformly distributed solid particles and the dispersion being flowable at room temperature.
